(19) United States
(12) Patent Application Publication
(10) Pub. No.: US 2006/0146024 A1
(43) Pub. Date: Jul. 6, 2006

(54) Digital information search method and its system

(76) Inventor: Pei Chen, Beijing (CN)

Correspondence Address: GLOBAL IP SERVICES, 2462 ROCK ST., APT. 6, MOUNTAIN VIEW, CA, 94043, US

(21) Appl. No.: 11/203,715

(22) Filed: Aug. 15, 2005

(30) Foreign Application Priority Data
Dec. 30, 2004 (CN) 2004101035324

(51) Int. Cl. G09G 5/08

(52) U.S. Cl. 345/163

(57) ABSTRACT

An invention relates to a mouse word-marking method, which is executed in the text fields of all the applications on the desktop, and a system to realize said method. Said method comprises the following steps: 1. The mouse marks and selects the key word(s) from the text fields of any application on the desktop; 2. Decide whether the selected word(s) is on the desktop. If YES, acquire the selected word(s); 3. Further decide whether the bytes of the selected key word(s) are smaller than the set value. If YES, a search button will pop up; 4. Click the button, and the server will execute the search and return the results to the user end; 5. The mouse waits for the next word-marking action on the desktop. The user can also right click the mouse to pop up a menu with search options. Select a search option and the server will execute the search. Alternatively, after acquisition of the selected word(s), drag the mouse at random, and the server will execute the search. Therefore, the user can acquire the searched information simply by using the mouse without opening a browser and inputting key words.

In the information era, digital information search is becoming increasingly important, and is characterized by Internet information search. To date the Internet is developing at great speed, and the number of Internet users is increasing tremendously. In the meantime, information on the Internet is also eruptive. Information search on the Internet has now become an important way of information acquisition in people's work, life and studies.

Usually, Internet search methods can be summarized in the following four steps:
1. Open a browser;
2. Input website URLs to be searched;
3. Input keywords into the search box;
4. Click SEARCH to get the result, same as search methods used in portal or search websites. Correspondingly, in order to obtain information on the Internet, users generally open a browser to find if there is any content that interests them by visiting a few portal websites, and then visit several related websites one by one to search for the latest developments. This search method has caused inconvenience to the users, as the whole process is done manually, which is time-consuming and tends to miss necessary information. Every single search performed by the user involves a lot of repetitions, which results in inefficiency and harassment of overwhelming pop-up advertisements.

### SUMMARY OF THE INVENTION

In regard to the weaknesses of said search methods, this invention tries to tackle the technological problem of providing a search method, which uses only the mouse to perform information search without opening a browser to access search engines. This method can simplify the user's search steps and avoid a great deal of repetitive work in information search tremendously.

Another technical problem that this invention tries to solve is to provide a system that applies said search method, thereby to improve search efficiency.

To achieve the aforesaid goal, said computer desktop word-marking search method involves the following steps:
(1) The user defines the mode of mouse word-marking search;
(2) The user defines the scope of mouse word-marking search;
(3) The user starts mouse word-marking search, which involves:
   1) Capture the message held down by the left mouse button;
   2) Decide whether it is on the desktop. If NO, return to Step A;
   3) If the judgment in Step 2) is YES, track the mouse word-marking action, and import the selected words into the invisible search box;
   4) Capture the message upon release of the left mouse button;
   5) Acquire selected keywords;
The indexing service communication module submits the keywords to the server for the search according to the mode of mouse word-marking search defined by the user and feedback the search results to the user.

Said user defined mouse word-marking search mode involves the following steps:
(1) Capture the message held down by the left mouse button and acquire selected keywords;
(2) Decide whether the bytes of the selected content are smaller than the set value. If NO, return to Step (1);
(3) If the judgment is YES in Step (2), a search button pops up;
(4) Decide whether to click the button. If NO, return to Step (1);
(5) If the judgment is YES in Step (4), further decide whether to left-click the button. If YES, start indexing service communication module;
(6) The indexing service communication module transmits the word(s) to be searched to the server for the search;
(7) Return the searched information to the user end;
(8) Return to Step (1);
(9) If the judgment whether to left-click the button in Step (5) is NO, a right button menu pops up;
(10) Choose the EXIT option in the right button menu, and the search process will close herein;
Choose the corresponding search option, the indexing service communication module will start and complete Steps (6) to (8).

Said user defined mouse word-marking search method can also be realized in the following steps:
(1) Capture the message held down by the left mouse button and acquire the selected keywords;
(2) Decide whether to right-click the button. If NO, return to Step (1);
(3) If the judgment in Step (2) is YES, the right button menu pops up;
(4) Decide whether to select the search option. If YES, the indexing service communication module will start;
(5) The indexing service communication module transmits the word(s) to be searched to the server for the search;
(6) Return the searched information to the user end
(7) Return to Step (1);
(8) If the judgment in Step (4) is NO, further decide whether to select the EXIT option. If NO, return to Step (1);
(9) If the judgment whether to select the EXIT option in Step (8) is YES, the search process will close herein.

Said user defined mouse word-marking search method can also be realized in the following steps:
(1) Capture the message held down by the left mouse button, and acquire the selected keywords;
(2) Decide whether the bytes of the selected content are smaller than the set value. If NO, return to Step (1);
(3) If the judgment in Step (2) is YES, further decide whether to drag the mouse at random. If NO, return to Step (1);
(4) If the judgment whether to drag the mouse at random in Step (3) is YES, the indexing service communication module will start;
(5) The indexing service communication module transmits the word(s) to be searched to the server for the search;
(6) Return the acquired index information to the user end;
(7) Return to Step (1).

Said set value of the bytes is a natural number of N. Set value N=40 is the system default value.

The client end communication module work flow is as follows:
(1) Receive related word(s) to be searched through client end communication module;
(2) Decide whether the word(s) to be searched is valid. If NO, this process will close herein;
(3) If the judgment in Step (2) is YES, choose the category of the information to be searched, and submit it to the server for the search;
(4) Wait for the server to feedback the information;
(5) Display the returned information to the user. The server indexing process works as follows:
(1) Client end sends a request to the server;
(2) Server acquires the word(s) to be searched;
(3) Decides on the indexing category;
(4) Acquires searched information;
(5) Returns searched information to the user end.

The returned information can be directly displayed to the user.

The computer desktop word-marking search system to realize said method involves:

A computer with at least one memory device,

An index device,

A search server,

A user interface to communicate with the search server, And a mouse that can execute desktop word-marking search.

Said method requires two work fields for word-marking search, which correspond to the left and right buttons of the mouse.

The left mouse button is the work field to mark words in the text fields of the applications and execute search steps.

The left mouse button is the work field to click the search button popped up after word-marking, and to execute search steps.

The left mouse button is the work field to drag at random after word-marking, and to execute search steps.

The right mouse button is the work field to pop up the search option menu after word-marking by the left button, and to execute search steps.

Judging from the above information, and in comparison with traditional search methods, mouse desktop word-marking of said invention can relieve the user from a lot of repetitive work and improve search efficiency. Following is the comparison table for said search methods:

| | Using word-marking | Traditional search |
|---|---|---|
| Steps | search | methods |
| 1 | Start computer and Word | Start computer and Word |
| 2 | Unnecessary | Open a browser |
| 3 | Unnecessary | Input the URL of the |
| | | search engine |
| 4 | No need to input but by | Input keywords |
| | word-marking | |
| 5 | Click Search and get | Click Search and get |
| | results | results |

From the above table, it can be concluded that the content disclosed in said invention eliminates two steps in conventional search processes, i.e., without neither need to open a browser nor to input the URL of the search engine. In this way, search can be fulfilled in the text fields of all applications on the desktop. The user can reach search goals without neither starting the browser again and again, nor inputting related URLs for many times.

In addition, said invention also simplifies the step of inputting keywords as in conventional search methods, which require input of keywords to be searched. In said invention, however, only the mouse is needed for word-marking in desktop text fields, instead of relying on such input devices like the keyboard to input keywords. It helps simplify the search process. For those who are eager to search information and yet unfamiliar with input methods and not used to keyboard use, said method can be of great assistance.

A mouse that applies said method can execute word-marking search in the text fields of all applications on the desktop. It is unnecessary to open any browsers, or to use any search engines, or to input URLs, or to input keywords. It is truly a great achievement in this field.

### DESCRIPTION OF THE DRAWINGS

FIG. 1 is the schematic diagram of the overall system structure to apply said method.

FIG. 2 is the flow chart of event capturing by the mouse.

FIG. 3 is the flow chart of user word-marking to pop up the search button.

FIG. 4 is the flow chart of user word-marking, mouse right-clicking to pop up the search button.

FIG. 5 is the flow chart of user word-marking, random clicking for the search.

FIG. 6 is the work flow chart of client end communication module.

FIG. 7 is the flow chart of server indexing.

### DESCRIPTION OF THE PREFERRED EMBODIMENT

The invention relates to the word “desktop”, which refers to the interface between the user and the computer, instead of the desktop platform in the Windows system in particular.

Said invention is further illustrated with the following embodiments. However, the method and the system are not limited to these embodiments.

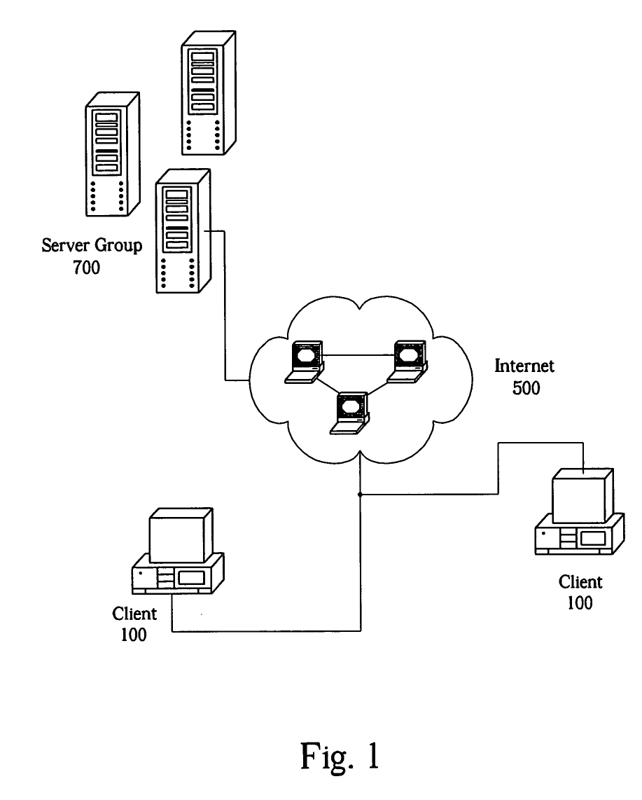

As illustrated in FIG. 1, the schematic diagram of overall system structure for said invention comprises Client End Computer 100, Internet 500 and Server Group 700. The client end offers word(s) to be searched, and submits it to the server, which executes the search on the Internet and returns search results to the client end. In using said method, the workload on the client end in particular, is reduced dramatically in this process.

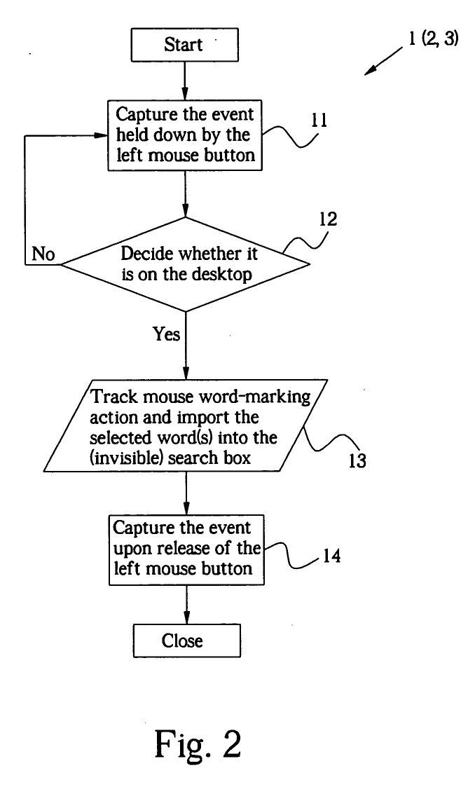

As illustrated in FIG. 2, the user holds down the left button and captures the event held down by the left mouse button in Step 11. In Step 12, decide whether it is on the desktop. If NO, return to Step 11 and wait for the next left mouse button action. If the judgment in Step 12 is YES, track mouse word-marking action in Step 13 and import the word(s) selected into the hidden search box. In Step 14, capture the event upon release of the left mouse button and acquire the keywords.

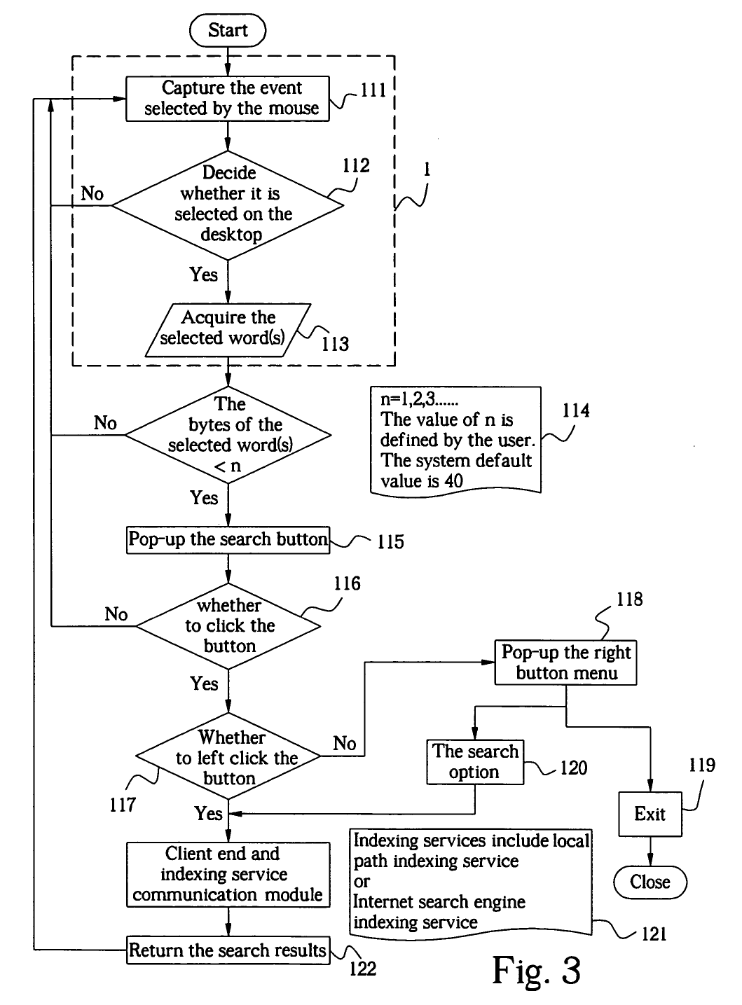

As illustrated in FIG. 3, the steps illustrated in FIG. 2 are simplified into the steps in Box 1. In Step 111, the user applies mouse word-marking to select the word(s) to be searched, i.e., to capture the event. In Step 112, decide whether the word(s) to be searched is selected on the computer desktop. If NO, return to Step 111 and wait for the next mouse word-marking to capture the event. If YES, the word(s) to be searched is acquired in Step 113. In Step 114, decide whether the bytes of the acquired index words are smaller than the set value, which is a natural number defined by the user. The system default value is 40, with the purpose to distinguish word-marking and copy action from word-marking and search action. If NO, it indicates an overflow of the selected words, it should be a copy operation. Return to Step 111 and wait for the next mouse word-marking action. If the bytes of the word(s) to be searched are found to be smaller than the set value, proceed to Step 115 where a search button will pop up. In Step 116, decide whether to click the pop-up button. If NO, return to Step 111 and wait for the next mouse word-marking action. If the judgment is YES in Step 116, further decide whether to left-click the button in Step 117. If the judgment is NO in Step 117, the right button menu pops up in Step 118. In Step 119, if the EXIT option is selected, this search action will close herein. In Step 120, if the corresponding search option is selected, the indexing service module receives the search option sent by the client end in Step 121. Related indexing services include local path indexing service or Internet search engine indexing service. If the judgment is YES in Step 117, Step 121 is executed. In Step 122, the server feeds the searched information back to the client. Return to Step 111 and wait for the next mouse word-marking search action.

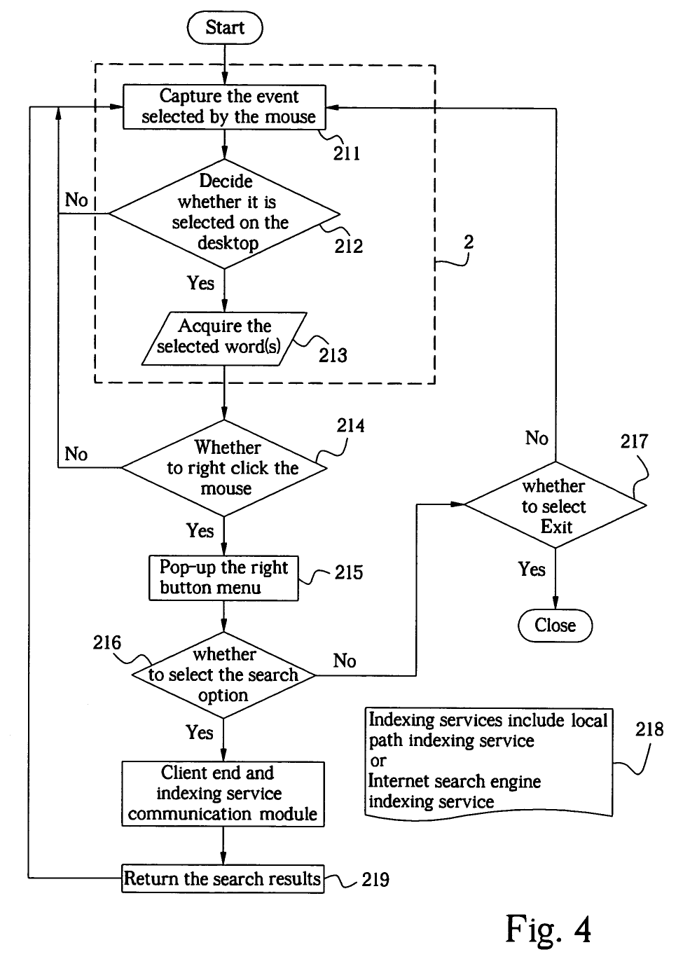

As illustrated in FIG. 4, mouse word-marking search can also be realized in the following way. Simplify the steps illustrated in FIG. 2 into the steps in Box 2. In Step 211, the user applies mouse word-marking to select the word(s) to be searched, i.e., to capture the event. In Step 212, decide whether the word(s) to be searched is selected on the computer desktop. If NO, return to Step 211 and wait for the next mouse word-marking to capture the event. If YES, however, acquire the word(s) to be searched in Step 213. In Step 214, decide whether to right-click the mouse button. If NO, return to Step 211 and wait for the next mouse word-marking action. If YES, proceed to Step 215 and the right button menu will pop up. In Step 216, decide whether to select the search option. If NO, further decide whether to select EXIT in Step 217. If the judgment is NO in Step 217, return to Step 211 and wait for the next mouse word-marking action. If the judgment is YES in Step 217, this search process will close herein. If the judgment whether to select the search option in Step 216 is YES, the indexing service module receives the search option sent by the client end in Step 218. Indexing services include local path indexing service or Internet search engine indexing service. In Step 219, the server feeds the searched information back to the client. Return to Step 211 and wait for the next mouse word-marking search action.

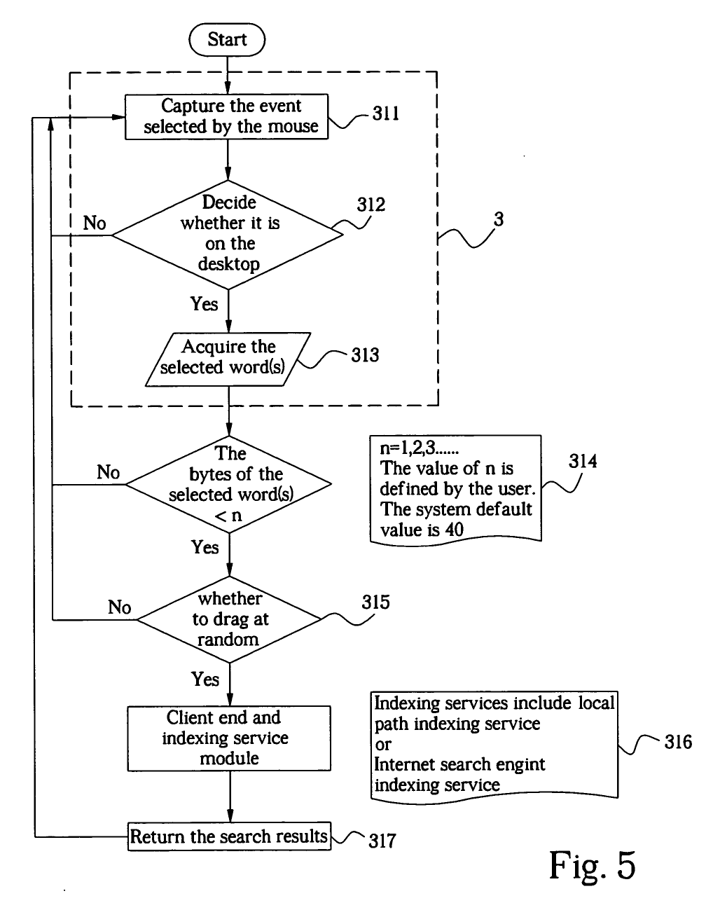

As illustrated in FIG. 5, mouse word-marking search can also be realized in the following way. Simplify the steps illustrated in FIG. 2 into the steps in Box 3. In Step 311, the user applies mouse word-marking to select the word(s) to be searched, i.e., to capture the event. In Step 312, decide whether the word(s) to be searched is selected on the computer desktop. If NO, return to Step 311 and wait for the next mouse word-marking to select the event. If YES, the word(s) to be searched will be acquired in Step 313. In Step 314, decide whether the bytes of the acquired index word(s) are smaller than the set value, which is a natural number defined by the user. The system default value is 40, with the purpose to distinguish word-marking and copy action from word-marking and search action. If NO, it indicates an overflow of the selected words, it should be a copy operation. Return to Step 311 and wait for the next mouse word-marking action. If the bytes of the word(s) to be searched are found to be smaller than the set value, further decide whether to drag the mouse at random in Step 315. If NO, return to Step 311 and wait for the next mouse word-marking action. If the judgment is YES in Step 315, the indexing service module receives the search option sent by the client end in Step 316. Indexing services include local path indexing service or Internet search engine indexing service. In Step 317, the server feeds the searched information back to the client. Return to Step 311 and wait for the next mouse word-marking search action.

Prior to and while applying said invention, the user may choose among the aforesaid three search methods. The user may choose a single search method or apply any two search methods, or all three search methods. Besides, prior to and while applying said invention, the user may select the search scope. The user may select all files in the local computer or files under a designated path, and may as well select an Internet search engine, or both aforesaid scopes.

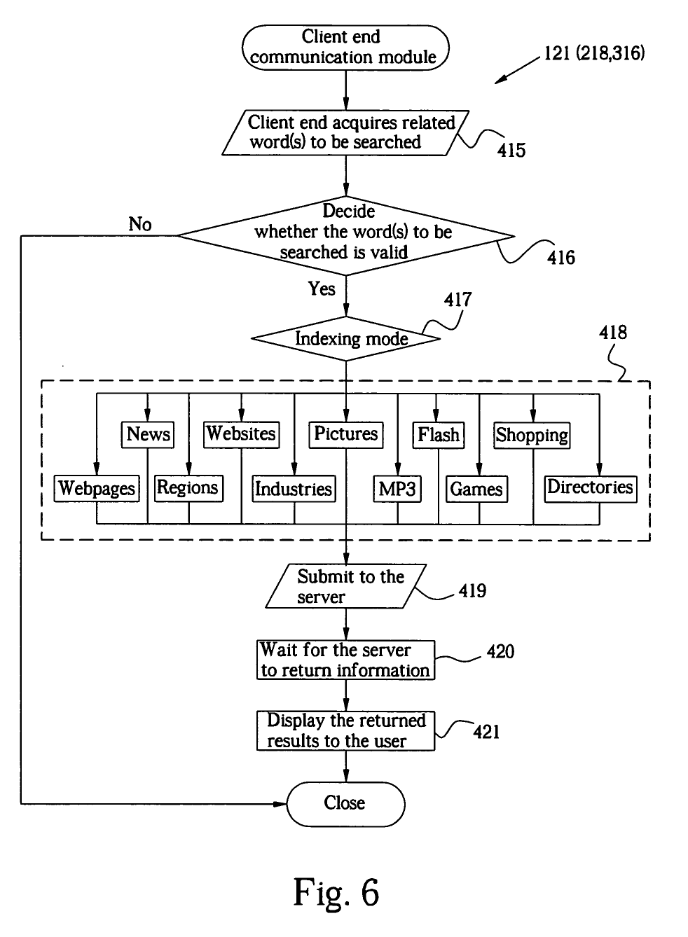

As illustrated in FIG. 6, the indexing service module receives the search option sent by the client in Step 415. In Step 416, decide whether the search information transmitted is valid, for example, whether the word(s) to be searched is valid. If the judgment is NO in Step 416, this search process will close herein. If the judgment is YES in Step 416, further decide in Step 417 the indexing mode to be applied for the word(s) to be searched. In Step 418, select one indexing mode, like searching web pages, news, regions, websites, industries, pictures, MP3, flash, games, shopping and directories. In Step 419, submit the selected indexing mode in Step 418 to the server. In Step 420, wait for the server feedback. In Step 421, the server displays the returned information to the user. The process is complete herein.

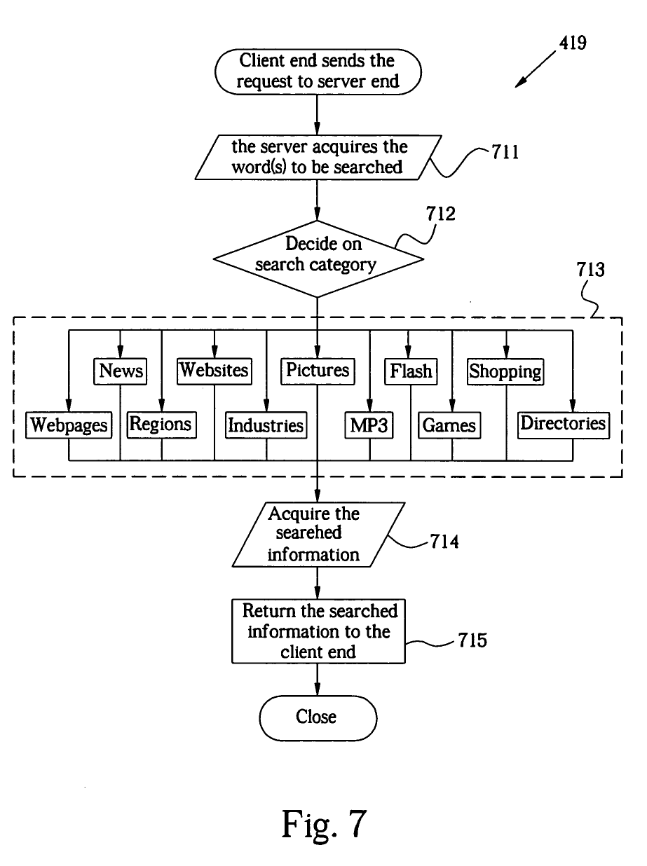

As illustrated in FIG. 7, the server acquires the information to be searched after receiving the request sent by the client end in Step 711, such as the index words. In Step 712, decide the information category to be searched. In Step 713, select one search category, like searching web pages, news, regions, websites, industries, pictures, MP3, flash, games, shopping and directories. In Step 714, the searched information is acquired. In Step 715, the server transmits the searched information to the user. The process is complete herein.

In this way, a search button pops up upon release of the left mouse button after word-marking, which means a search can be executed by left-clicking the button, and the content searched is displayed directly to the user. Or, after left mouse button word-marking, right-click the mouse button and a menu of search options will popup. Click this search option and the search process will start and the results will be directly displayed to the user. Or, after left mouse button word-marking, the user holds down the left mouse button and drags it at random, which will display the search results directly to the user desktop.

In accordance with the disclosure of the invention, the user can directly accomplish search goals without inputting any keywords via the keyboard. All that is necessary is to perform mouse word-marking in the text fields of all applications on the computer desktop. Therefore, the mouse, which realizes said method in the operational system, replaces the keyboard—the conventional hardware of information input. This facilitates the search operation. Besides, said invention enables the user to capture any information to be searched on the spot. It serves to eliminate the repetitive keyboard input work in entering portal websites or search engines for several times, and to improve search efficiency for the user.

Although the invention has been described in connection with a preferred embodiment, it should be understood that various modifications, additions and alterations (such as switching the left and right work fields for the mouse so as to perform word-marking or random dragging for the search with the right mouse button) may be made to the invention by one skilled in the art without departing from the spirit and scope of the invention as defined in the appended claims.

What is claimed is:

1. A desktop word-marking search method comprises the following steps:
1) define a mouse word-marking search mode;
2) define said mouse word-marking search scope;
3) start said mouse word-marking search steps, which includes:
A. Capture a message of holding down by the left mouse button;
B. Decide whether said message is on said desktop, if NO, return to Step A;
C. If a judgment in the Step B is YES, track the mouse word-marking action, and import the selected word(s) into an invisible search box;
D. Capture a message of releasing of the left mouse button;
E. Capture said selected key word(s);
F. In accordance with the defined mouse word-marking mode, an indexing service communication module submits said key word(s) to a server for search and returns search results to user end.

2. The desktop word-marking search method of claim 1 wherein said mouse word-marking search mode comprises the following steps:
1) Capture said message by holding down said left mouse button to acquire said key word(s);
2) Decide whether the bytes of said key word(s) is smaller than a set value, if NO, return to Step 1);
3) If the judgment in Step 2) is YES, a search button will popup;
4) Decide whether click said search button, if NO, return to Step 1);
5) If the judgment in Step 4) is YES, further decide whether click said left button, if YES, said indexing service communication module will start;
6) said indexing service communication module transmits said key word(s) to said server for search;
7) Return the acquired information to user end;
8) Return to Step 1);
9) If the judgment in Step 5) is NO, said right button menu will popup;
10) If users choose an exit option in said right button menu, the searching program will close herein.
11) If users choose a search option in said right button menu, said indexing service communication module will start, and complete Step 6) to Step 8).

3. The desktop word-marking search method of claim 1 wherein said mouse word-marking search mode comprises the following steps:
1) Capture the message of holding down said left mouse button, and acquire said selected key word(s);
2) Decide whether click said right button of the mouse, if YES, return to Step 1);
3) If the judgment in Step 2) is YES, a right-button menu will pop up;
4) Decide whether to select a search option, if YES, an indexing service communication module will start;
5) said indexing service communication module transmits said selected key word(s) to said server for the search;
6) Return the acquired information to the user end;
7) Return to Step 1);
8) If the judgment in Step 4) is No, further decide whether to choose an EXIT option. If No, return to Step 1);
9) If the judgment whether to choose the EXIT option in Step 8) is YES, the search process will close herein.

4. The desktop word-marking search method of claim 1 wherein said mouse word-marking search mode comprises the following steps:
1) Capture the message of holding down said left mouse button, and acquire said selected key word(s);
2) Decide whether the bytes of said key word(s) are smaller than a set value. If No, return to Step 1);
3) If the judgment in Step 2) is YES, further decide whether drag said mouse at random. If NO, return to Step 1);
4) If the judgment whether to drag the mouse at random in Step 3) is YES, said indexing service communication module will start;
5) said indexing service communication module transmits said key word(s) to said server for search;
6) Return the acquired information to the user end;
7) Return to Step 1).

5. The desktop word-marking search method of claim 2 wherein the set value of said bytes is a natural number N.

6. The desktop word-marking search method of claim 4 wherein the set value of said bytes is a natural number N.

7. The desktop word-marking search method of claim 5 wherein said set value N=40 is the system default value.

8. The desktop word-marking search method of claim 6 wherein said set value N=40 is the system default value.

9. The desktop word-marking search method of claim 1 wherein a work flow of client end communication module comprises following steps:
1) Receive said key word(s) through said client end communication module;
2) Decide whether said key word(s) is valid, if NO, the work flow will close herein;
3) If the judgment in Step 2) is YES, select categories of information to be searched, and submit said selected categories to said server for search;
4) Wait for said server to return the acquired information;
5) Display the returned information to the user end.

10. The desktop word-marking search method of claim 2 wherein a work flow of client end communication module comprises following steps:
1) Receive said key word(s) through said client end communication module;
2) Decide whether said key word(s) is valid, if NO, the work flow will close herein;
3) If the judgment in Step 2) is YES, select categories of information to be searched, and submit said selected categories to said server for search;
4) Wait for said server to return the acquired information;
5) Display the returned information to the user end.

11. The desktop word-marking search method of claim 3 wherein a work flow of client end communication module comprises following steps:
1) Receive said key word(s) through said client end communication module;
2) Decide whether said key word(s) is valid, if NO, the work flow will close herein;
3) If the judgment in Step 2) is YES, select categories of information to be searched, and submit said selected categories to said server for search;
4) Wait for said server to return the acquired information;
5) Display the returned information to the user end.

12. The desktop word-marking search method of claim 4 wherein a work flow of client end communication module comprises following steps:
1) Receive said key word(s) through said client end communication module;
2) Decide whether said key word(s) is valid, if NO, the work flow will close herein;
3) If the judgment in Step 2) is YES, select categories of information to be searched, and submit said selected categories to said server for search;
4) Wait for said server to return the acquired information;
5) Display the returned information to the user end.

13. The desktop word-marking search method of claim 1 wherein said service process comprise the following steps:
1) the user end sends a request to said server;
2) said server acquires said key word(s);
3) decide on said search categories;
4) acquire searched information;
5) return the searched information to the user end.

14. A desktop word-marking search system comprises:
1) a computer which contains at least one memory device;
2) an indexing device;
3) a search server;
4) a user interface to communicate with said search server;
5) a mouse to be used to mark word(s) for the search on the desktop;
6) programs carrying out the desktop word-marking search method of claim 1.

15. The word-marking search system of claim 14 wherein the left and right buttons of said mouse correspond to two work fields

16. The word-marking search system of claim 15, wherein said left mouse button is a work field, it makes word-marking in text fields of applications and executes the search steps therein.

17. The word-marking search system of claim 15 wherein said left mouse button is a work field, it clicks the search button popped up after word-marking and executes the search steps therein.

18. The word-marking search system of claim 15 wherein said left mouse button is a work field, it drags at random after word-marking and executes the search steps therein.

19. The word-marking search system of claim 15 wherein said right mouse button is a work field, it clicks the search option menu popped up by the left mouse button after word-marking, and executes the search steps therein.
